(19) United States
(12) Patent Application Publication
(10) Pub. No.: US 2012/0209770 A1
(43) Pub. Date: Aug. 16, 2012

(54) System and Method for Monetizing Video Content

(76) Inventors: Subramanian Peruvemba, Santa Clara, CA (US); Lex Bayer, Menlo Park, CA (US); Kaushal N. Mehta, Fremont, CA (US)

(21) Appl. No.: 13/179,420

(22) Filed: Jul. 8, 2011

Related U.S. Application Data
(60) Provisional application No. 61/362,671, filed on Jul. 8, 2010.

(51) Int. Cl. G06Q 40/00

(52) U.S. Cl. 705/44; 705/39

(57) ABSTRACT

Methods and systems are presented for displaying multimedia content on a user computing device where the content includes several segments. A first segment of the content is displayed on the computing device and following display of the first segment of the content, a request for payment associated with a second segment of the content is displayed to the user. A user payment request approval for the second segment of the content is communicate from the user computing device to a service server, and the service server may respond with an approval or rejection. In a further potential embodiments, segments of the video may be defined and set by a content server, and varied based on feedback and history related to user payments.

The present application relates to systems, methods, and computer readable storage media related to monetizing multimedia content. More specifically, certain embodiments relate to rental of video content on the internet in segments.

### BACKGROUND

Computer networks and the advent of the Internet as an implementation of widely available network with easily distributable content has resulted is large volumes of content, such as videos and movies, made available to any device or user with a network connection. Because various impediments to direct payment for content, such as the problem of competing with pirated file sharing, the risks of fraud and identity theft associated with making payments over the network, and the established advertising model, direct monetization of multimedia content were a user pays for access to content has had a much smaller market than solutions that are monetized through advertising. While some examples of success exist for distribution of content, these solutions have several downsides.

Many current monetization solutions for video content rely on advertizing revenues, often from advertisements hosted on or around the video which make it difficult to collect revenues when a video is distributed on external sites that may employee different advertizing strategies.

On the other hand, the content providing services that do avoid advertising in favor of payments from user particularly suffer from the problem of requiring payment for content upfront before any direct experience of the content starts playing. This is a significant barrier to adoption and does not force an impulsive behavior from the user. Instead, current payment support does not take advantage of impulsive decision of the user but instead encourages an up front payment which allows opportunity for reconsideration of a purchase through a multi-step process that is usually associated with online credit or debit purchases. These multi-step processes also generally direct users away from the site or player that is presenting the content, providing additional opportunity for distraction, error and other problems and seams that detract from a user experience and from an impulse purchase.

Users are often unsure about the quality of the content or are not yet engaged in the story of a video content. This is especially true where the option is for a digital purchase that is not refundable, or a digital video rental with a short time limit to view the entire video. Similarly, content pools that require a monthly payment require a relatively large monthly up-front payment. Both of these models require up-front decision making that is not connected with the experience of the content that is being purchased.

Trailers and previews are a free simple method of trying to overcome the up front payment issue by providing an experience of the content. A trailer or preview of a video, however, is a simple advertisement and does not capture user in the middle of an actual viewing of the content. Trailers are typically fixed length productions and cannot be configured to be different lengths. Trailers additionally suffer as advertisements that may provide unwanted details from content, spoiling the surprise and sometimes functioning to an opposite effect of spoiling or lessening a probability of converting a user to a paying customer.

Finally, current video players do not provide for embedded direct payment plug-ins or mechanisms.

For these and other reasons, there is a need for improved methods of providing and monetizing content over the internet.

### BRIEF SUMMARY

The present application relates to systems, methods, and computer readable storage media related to monetizing multimedia content.

In one potential embodiment, software and methods allow video renting/monetization of online videos wherein the user is allowed to view the videos up to a specified time or length of the video content and then prompted to pay to watch the remainder of the video. This method of content segmentation may be further enhanced with a single click payment using real or virtual currencies. By including a direct pay monetization plug-in directly into the video player, the video can be distributed easily on remote host sites and still be able to collect revenues for the original content publisher.

In an alternative embodiment, a method for displaying multimedia content comprises displaying, on a user computing device, a first segment of a content, wherein the content comprises a plurality of segments; displaying, on the user computing device, following display of the first segment of the content, a request for payment associated with a second segment of the content; and communicating from the user computing device to a service server, a user payment request approval for the second segment of the content. The embodiment may then further comprise receiving, at the user computing device, a transaction approval for payment of the second segment of the content and displaying, on the user computing device, the second segment of the content. As described in the embodiments disclosed herein, the content may be picture based multimedia content, animation, or filmed video.

In a further potential embodiment, segments of the video may be defined and set by a content server. Such segments may be defined by time segments, or by percentage of the total content. Additionally, the segments, periods, or percentage set by the server may vary depending on a categorization of the content. For example, movies with a length greater than 80 minutes may have a preview segment with the period set to end after the first five minutes, live sports events having an expected length greater than two hours may have a preview period of 10 minutes, and a sports summary show having a length of 30 minutes may have a preview segment ending after 2 minutes. Alternatively, all shows could have a preview period with a segment set for 5% of the show, where the exact period end to the preview segment would depend on the exact length of the show. These values may be further adjusted for each show, genre, or any other classification based on system feedback as described below.

In various embodiments, communications between elements of the embodiments may include a user ID that identifies a user. The user ID may be an account number, an e-mail address, a randomly assigned number, a user selected ID, a system assigned ID including additional information describing the user, or any other identifying ID. The system may further keep a database or other record that records a history of viewing and/or payment information associated with a user ID, and the segment length may be set or adjusted for a user based on the history. The history may be stored on a content server, a service server, on the user system within a multimedia player, or in any suitable format or location that may allow the history to be used to set segment lengths for the user or other similar users.

In certain embodiments, a player for presenting multimedia content over the Internet in segments includes a player module and a payment module. After a first segment has finished playing, a player module of the player that has been presenting the first segment to a display screen may transfer control of the player to a payment module that may present payment options to a user from within a player.

Further embodiments comprise identifying, using the user computing device and the player, a user ID; communicating the user ID from the user computing device to the service server; and receiving, from the service server prior to displaying the request for payment, a virtual currency account credit associated with the user ID.

In these embodiments displaying the request for payment may further comprise comparing the virtual currency account credit with a cost associated with the second segment of the content and displaying a single click approval interface when the virtual currency account credit is greater than the cost associated with the second segment of the content. After a single click approval the second segment may be displayed immediately. Additionally, communicating the user payment request approval may include communicating an approval selection, an ID associated with the content, and an ID associated with the player to the service server. Such IDs may be used for feedback and analysis systems operating to improve the system according to various implementations. Receiving, at the user computing device, the transaction approval for payment of the second segment of the content may include receiving, from the service server, an updated virtual currency account credit reflecting deduction of the cost associated with the second segment of the content.

Various embodiments may include registering with the service server prior to displaying of the first segment and communicating to the service server, prior to display of the first segment, credit card payment information. In these embodiments, the user payment request approval for the second segment of the content comprises an approval to pay for the second segment using the credit card payment information and receiving approval for payment of the second segment of the content comprises receiving a transaction authorization message from an issuer associated with the credit card payment information.

Embodiments may include displaying the second segment of the content directly upon an affirmative response to the request for payment associated with the second segment of the content. If an issue arises with payment from a local wallet or an indication of fraud, the displaying of the second segment of the content in response to receipt of a transaction rejection message from an issuer may be interrupted shortly after the segment begins playing.

Embodiments may further include receiving, at the user computing device, a second request to display the second segment of the content, checking, using the player, a payment history, and displaying, using the user computing device, the second segment of the content in response to a payment history record for the second segment of the content.

An alternative embodiment of the present innovations may comprise receiving at a server, a user payment request approval message indicating that a user computing device has displayed a first segment of a content and requesting approval for a payment associated with a second segment of the content verifying a registration status of the user associated with the user computing device and an association between the user and a payment account, accepting, at the server, payment for the second segment of the content, and communicating from the server to the user computing device, a transaction approval message associated with the second segment of the content. The user payment request approval message may comprise a user ID, a content ID, and a site ID. Such an embodiment may further comprise transferring, in response to accepting payment for the second segment of the content, a content payment to a content provider account associated with the content ID and a site payment to a site account associated with site ID.

An alternative embodiment of the present innovations may comprise formatting, using a content computer, the content for a player. The player may include imbedded payment and segment interrupt modules. The formatting may comprise selecting a preview segment for the content, selecting additional segments for the content, associating a cost for each segment other than the preview segment, and communicating, from the content computer to a user computing device, the content and the player.

### BRIEF DESCRIPTION

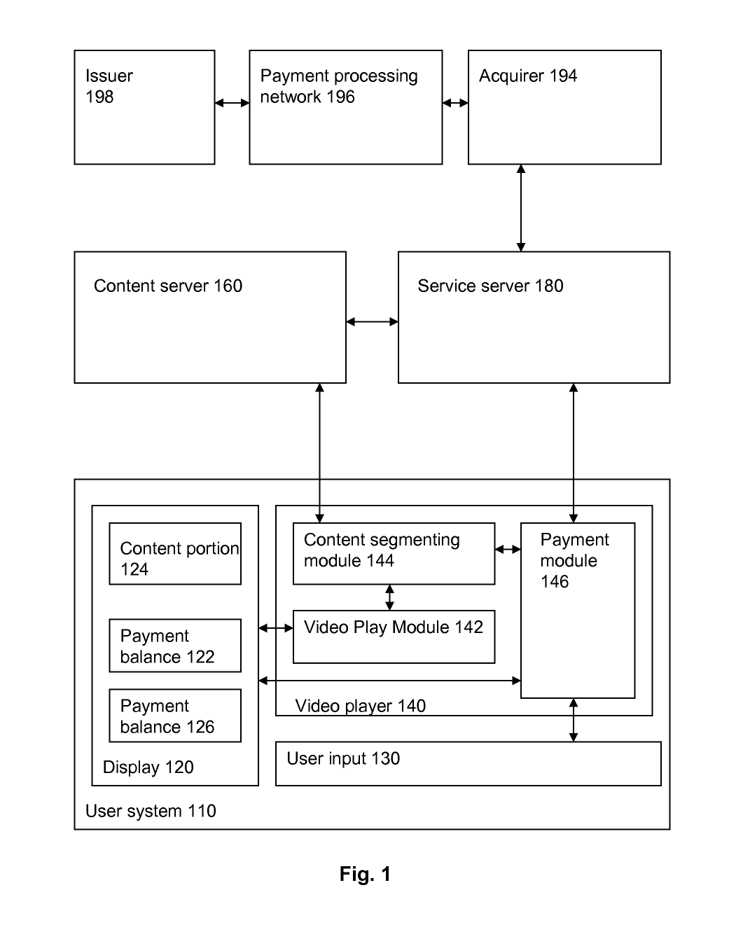

FIG. 1 shows a diagram of a system according to one potential embodiment of the innovations presented herein.

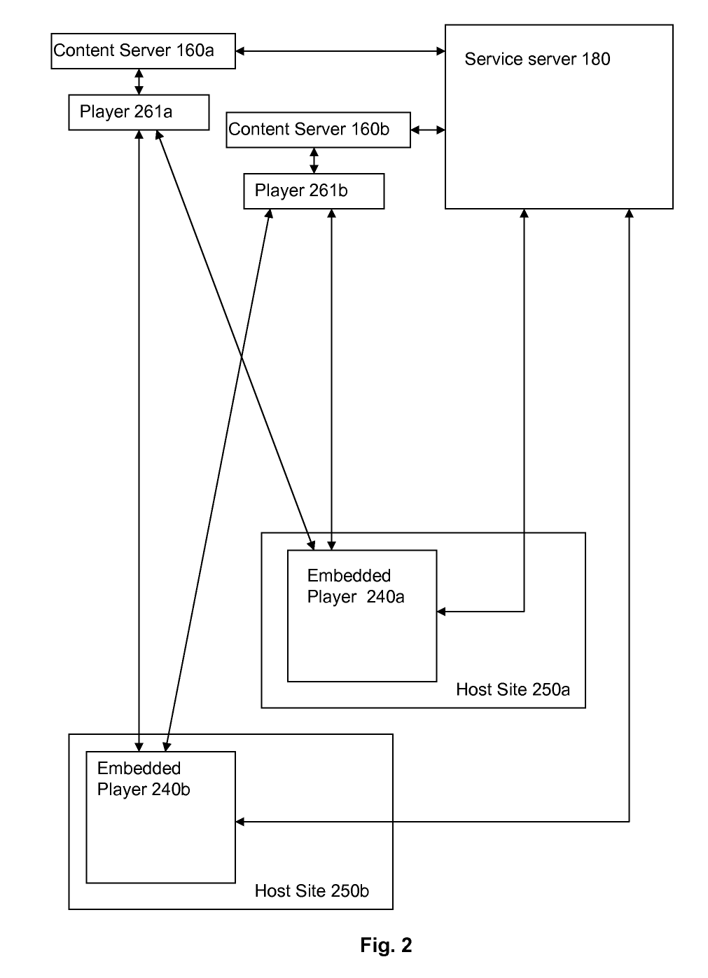

FIG. 2 shows a diagram of a system according to one potential embodiment of the innovations presented herein.

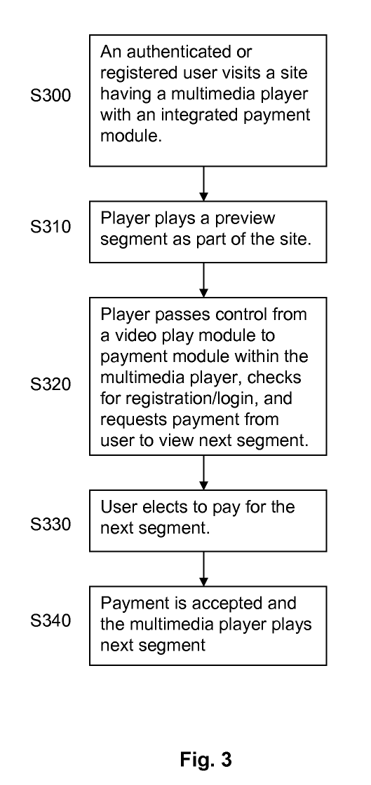

FIG. 3 shows a flowchart illustrating one potential embodiment of the innovations presented herein.

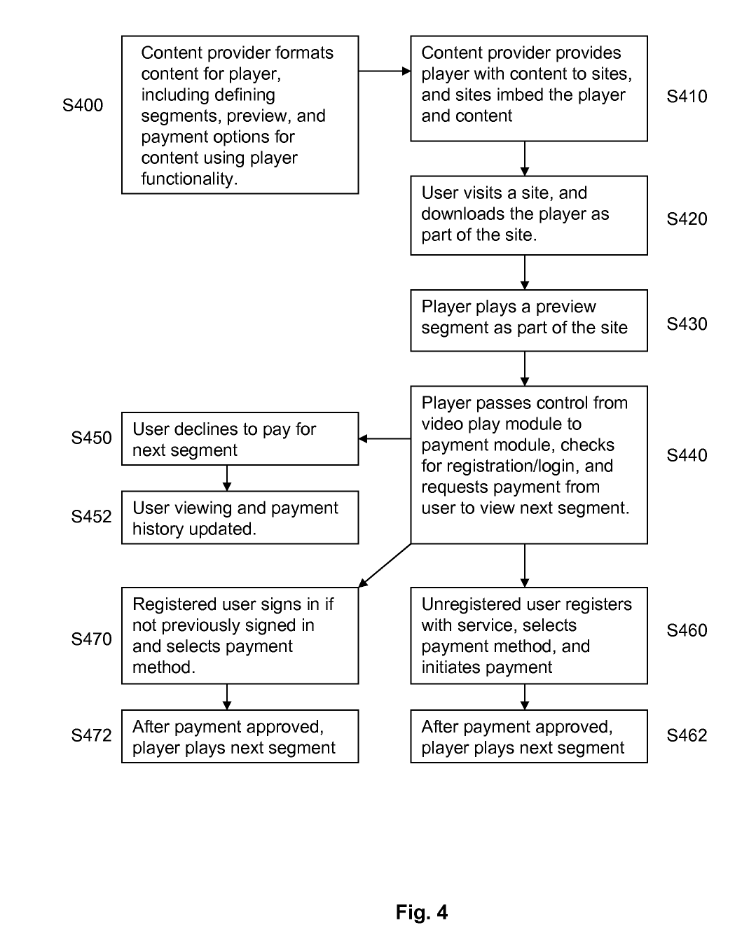

FIG. 4 shows a flowchart illustrating one potential embodiment of the innovations presented herein.

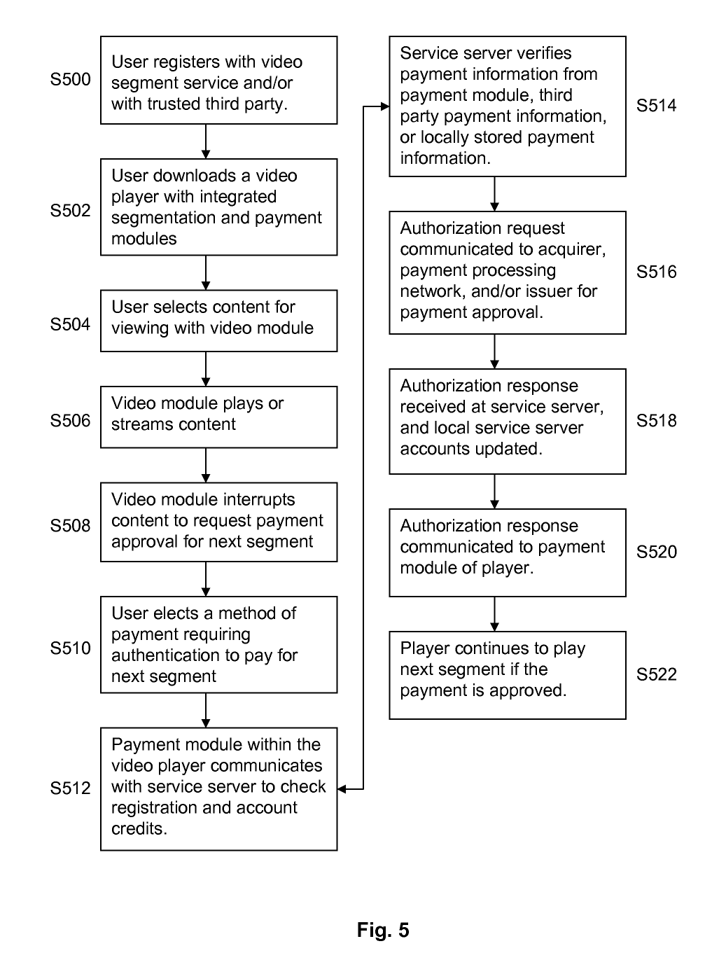

FIG. 5 shows a flowchart illustrating one potential embodiment of the innovations presented herein.

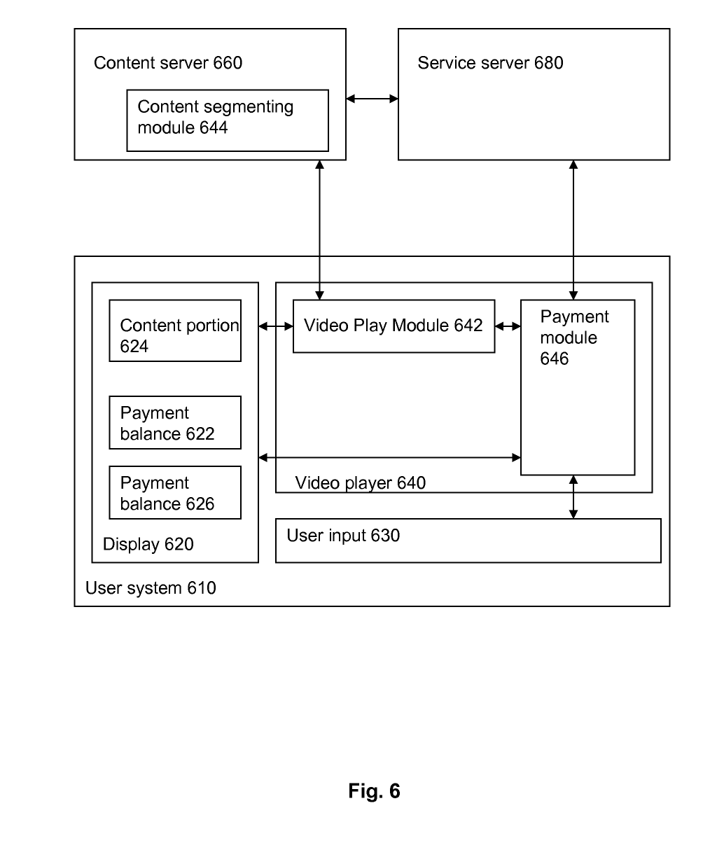

FIG. 6 shows a diagram of a system according to one potential embodiment of the innovations presented herein.

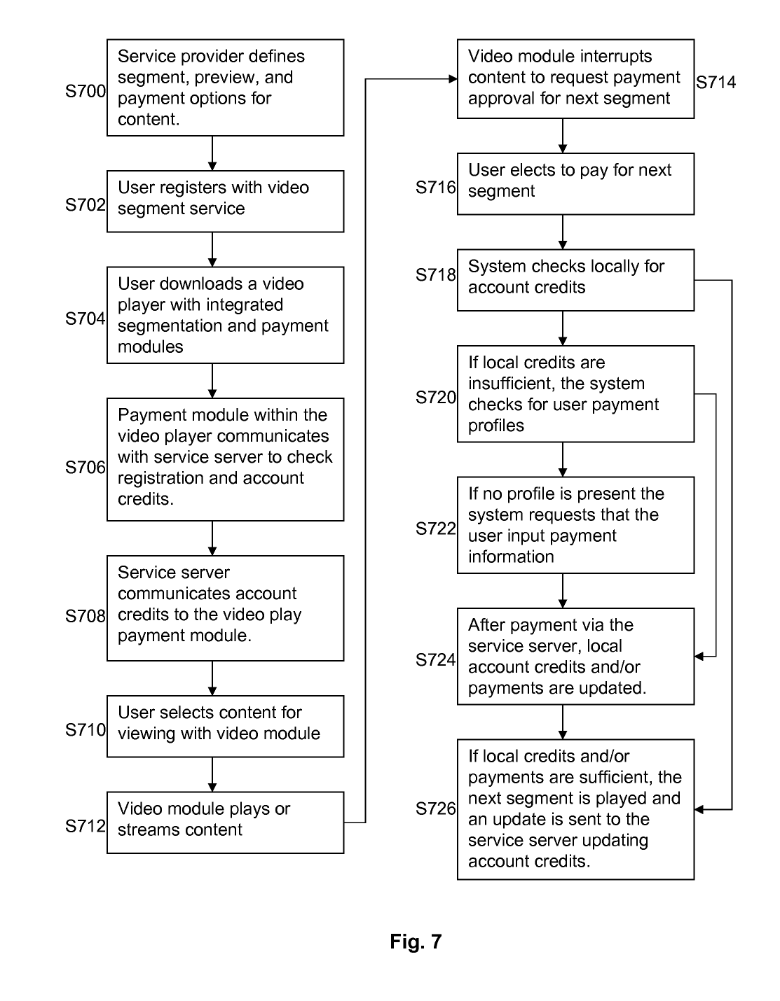

FIG. 7 shows a flowchart illustrating one potential embodiment of the innovations presented herein.

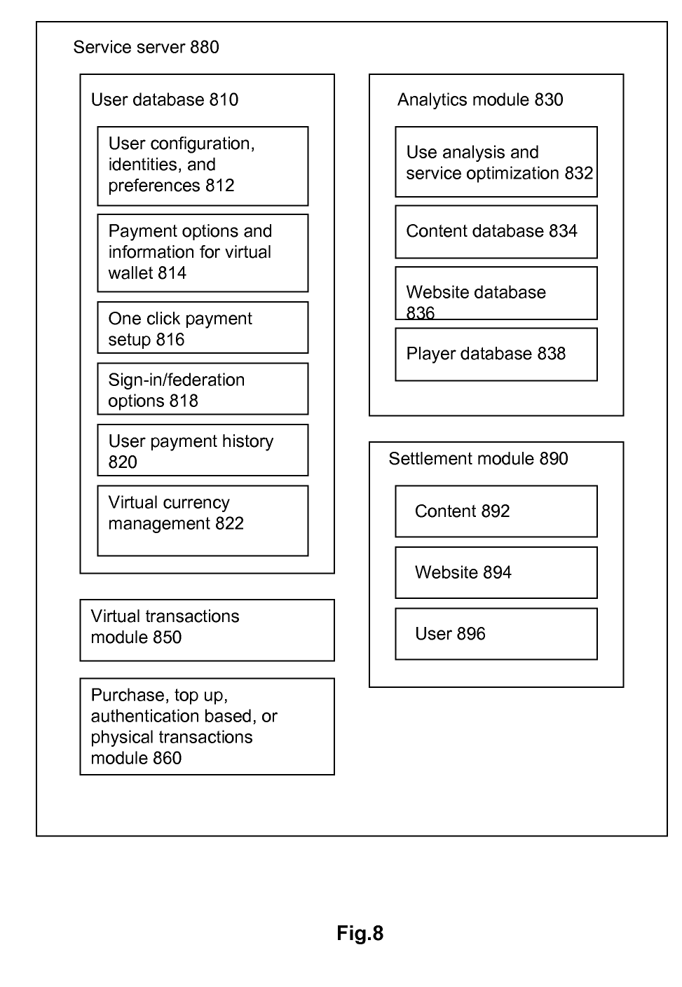

FIG. 8 shows a diagram of a system according to one potential embodiment of the innovations presented herein.

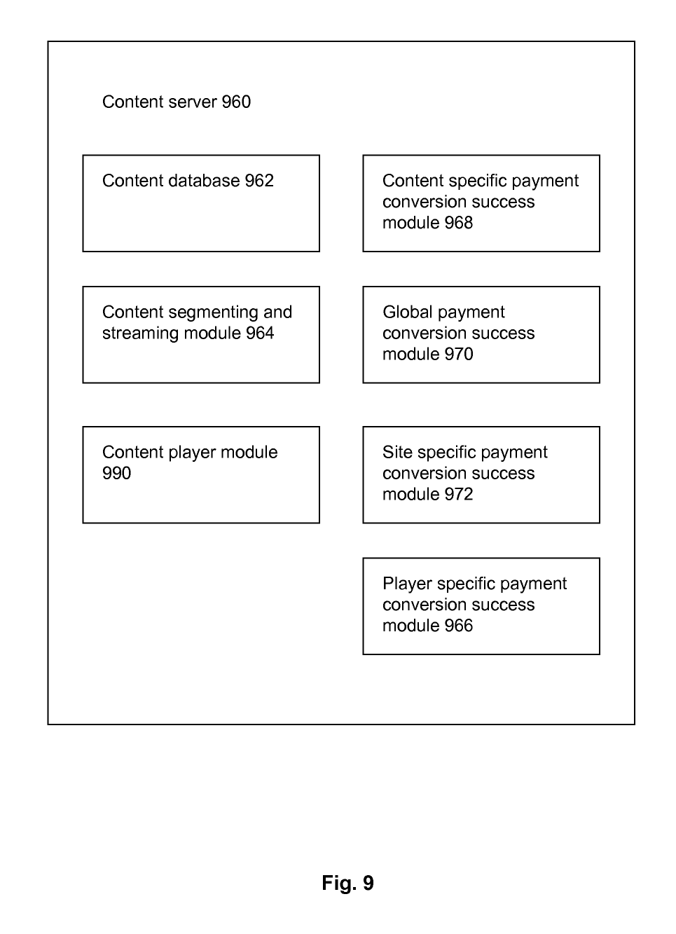

FIG. 9 shows a diagram of a system according to one potential embodiment of the innovations presented herein.

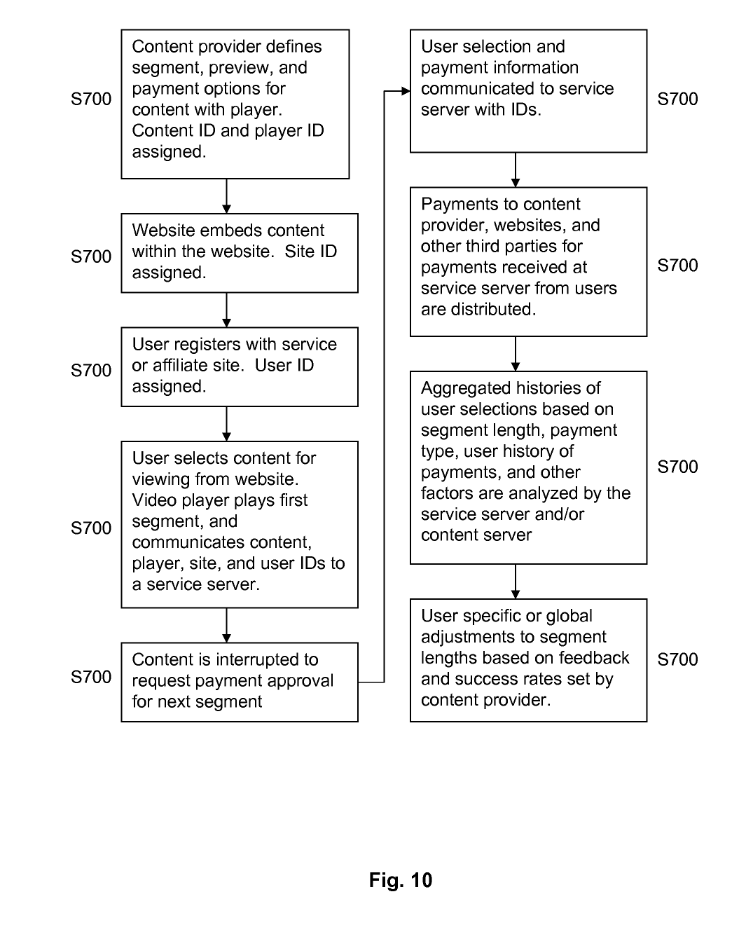

FIG. 10 shows a flowchart illustrating one potential embodiment of the innovations presented herein.

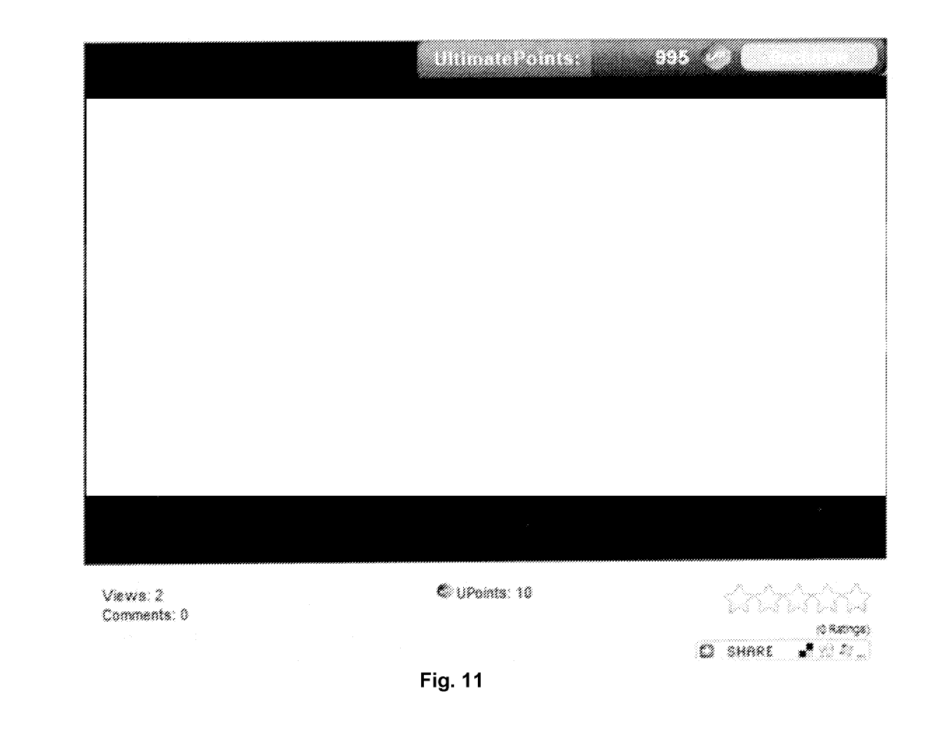

FIG. 11 shows an illustration of a display in accordance with one potential method of monetizing content in segments over the Internet.

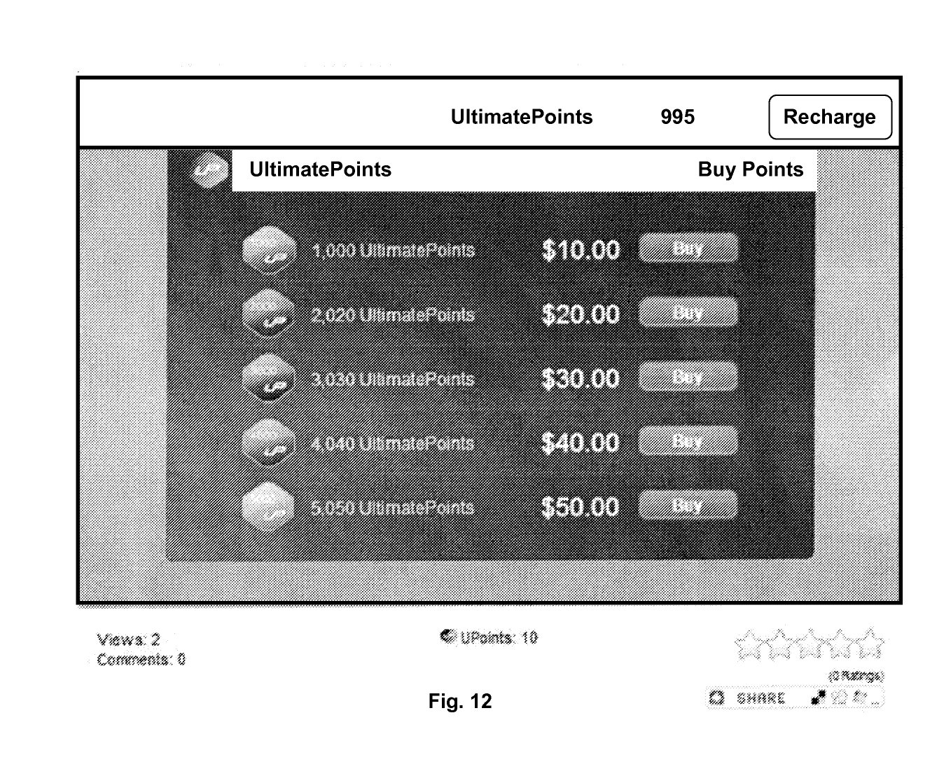

FIG. 12 shows an illustration of a display in accordance with one potential method of monetizing content in segments over the Internet.

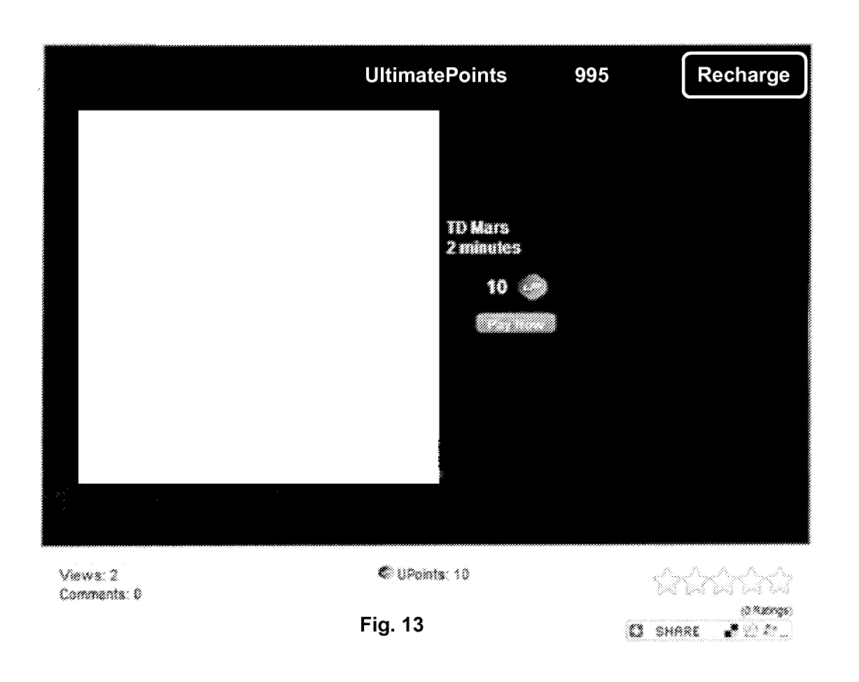

FIG. 13 shows an illustration of a display in accordance with one potential method of monetizing content in segments over the Internet.

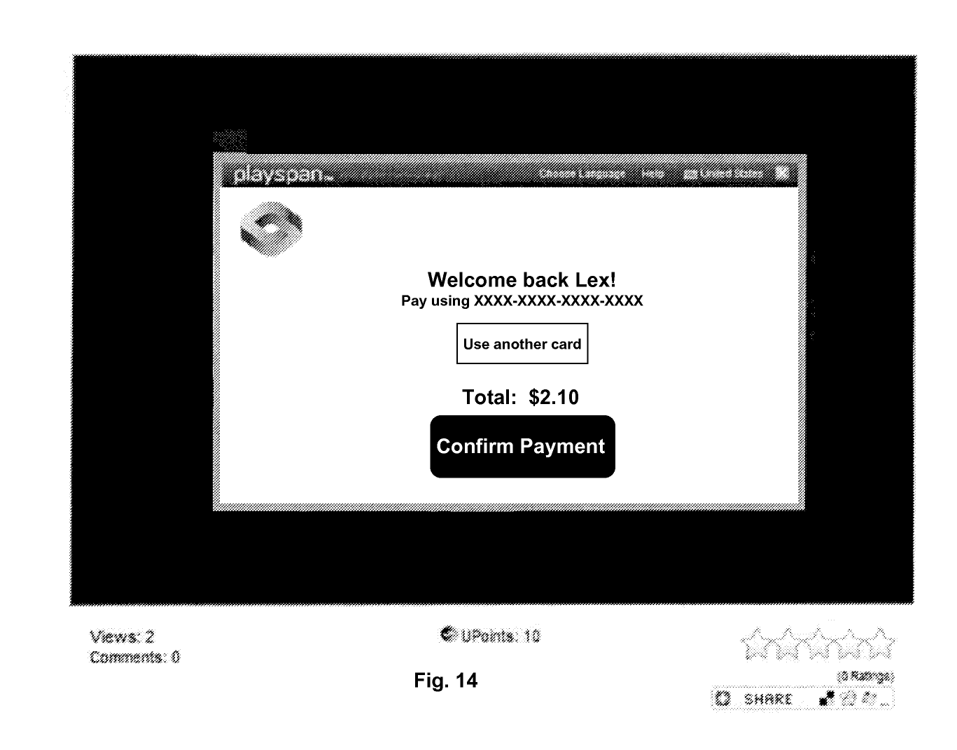

FIG. 14 shows an illustration of a display in accordance with one potential method of monetizing content in segments over the Internet.

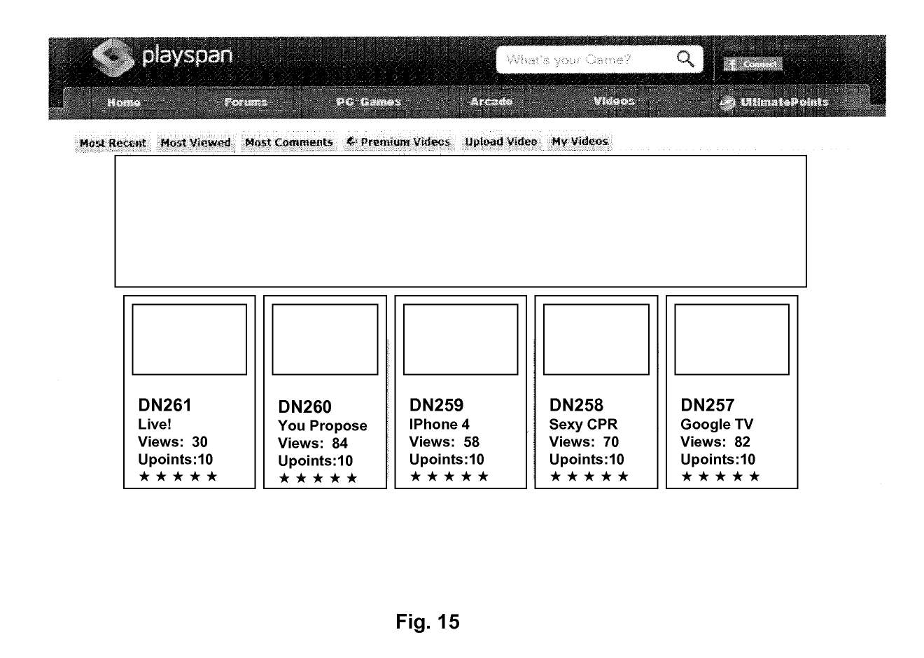

FIG. 15 shows an illustration of a display in accordance with one potential method of monetizing content in segments over the Internet.

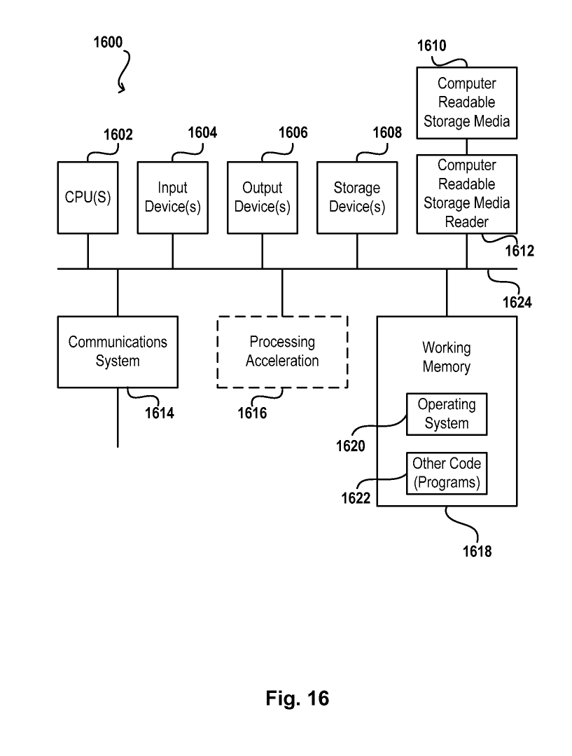

FIG. 16 shows a diagram of a system according to one potential embodiment of the innovations presented herein.

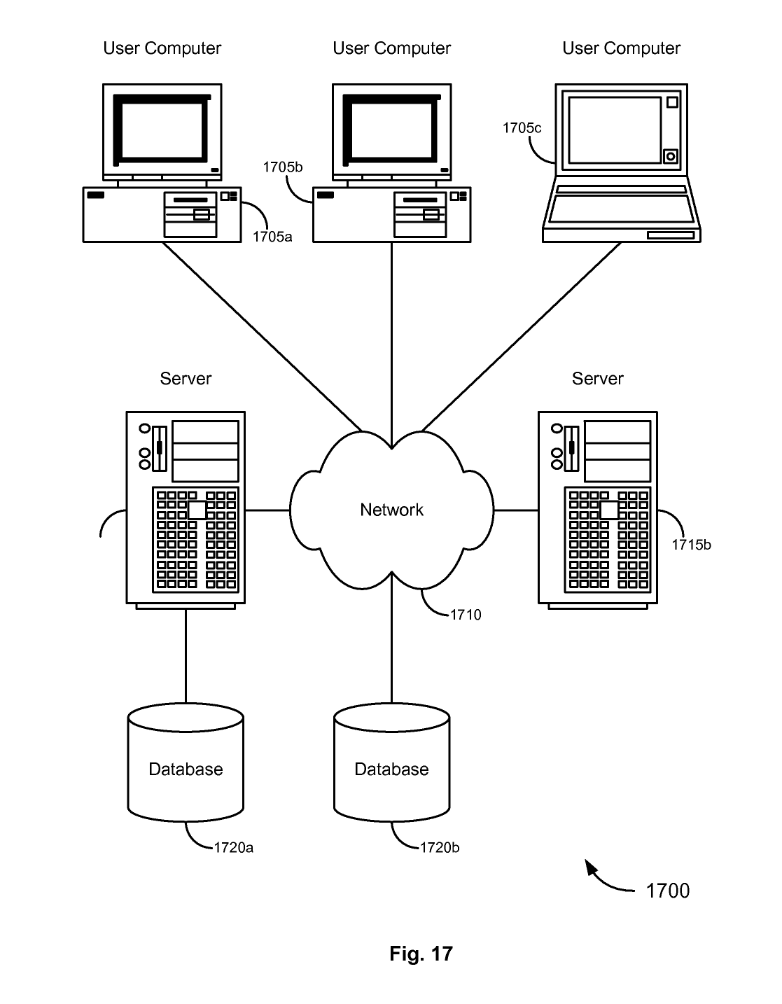

FIG. 17 shows a diagram of a system according to one potential embodiment of the innovations presented herein.

### DETAILED DESCRIPTION

A detailed description will now be provided for a system and method of renting video content over the Internet in segments.

In a basic non-limiting embodiment, a user browsing a site with a user computing device is allowed to view an initial segment of a movie up to a specified time or length of the video content. After the user has viewed the initial segment, an payment module integrated with the movie player prompts the user to pay to watch the remainder of the video. Preferably, the prompt is enhanced by a previous registration so that a single click payment using real or virtual currencies may enable the next segment to be watched very shortly or instantly following the click to make the payment.

In further alternative embodiments the exact segmentation of video can be pre-specified by a content provider or distributer, and further refined based on current users pattern. For example a user, who do not pay or pays rarely, can start seeing the smaller segments before their required to pay. In a further embodiment, the amount of preview time can be varied in online testing to find the optimal preview time to drive users to pay for the remainder of the video.

One mechanism for employing a preview segment before a user is prompted to pay is as follows. At the time of uploading the content, the uploader specifies the amount of preview time to allow either as an absolute number (e.g. seconds) or as a fraction of the video length (e.g. 5%). During the playback, the video player keeps track of the current location in the video playback. At the specified time in the video when the free preview is over, an event is triggered by the player to stop the video from proceeding and locks the player from continuing. An overlay or pop-up may be launched in the center of the player that prompts a user to pay to continue. Upon the completion of a successful payment, the player is notified that the payment was completed and the video content is resumed.

Various embodiments of such systems and methods include benefits not known in the art. By including a direct pay monetization plug-in directly into the video player, the video can be distributed easily on remote host sites and still be able to collect revenues for the original content publisher. Further, such embodiments take advantage of impulsive decisions of the user, by providing a single click experience to pay for video content.

Further still, by integrating a payment module with the player, a payment may be accepted while seamlessly holding a position in the content and avoiding a distracting and jolting transition to a payment site and back to a content player. The content player may thus provide a benefit of doubling as a portable cash register or access point for a transaction that can be further integrated with simplified online payment systems such as a mobile wallet or virtual currencies. Additionally, the integration of a payment module with a player allows a feedback system to identify segment locations and users by payment rates, thus allowing improved conversion of users into paying users by identifying ideal content points for requesting payment, by rewarding frequent purchases, and potentially responding to frequent non-purchases with shorter preview segments.

FIG. 1 describes one potential non-limiting embodiment of a system that may be used for monetizing and distributing content segments via the Internet. FIG. 1 comprises a user system 110, a content server 160, a service server, 180, an acquirer server 194, a payment processing network 196, and an issuer server 198. In the embodiment described in FIG. 1, user system 110 comprises a display 120, a user input 130, and a video player 140. The video player comprises a video play module 142, a content segmenting module 144, and a payment module 146. The display 120 comprises a content portion 124, a payment balance portion 122, and an interrupt portion 126.

Content server 160 may be any computing device capable of communicating content to a user system 110. In certain embodiments, portions of a player may be integrated with content, or communicated with content to a user system, and provided by content server 160.

Service server 180 may be any computing device capable of receiving information from a payment module 146 of a user system 110 to enable authorization for viewing content segments on a user system that require payment. In certain embodiments a service center may authorize payment based on a virtual currency managed by the service server 180. In alternative embodiments, service server 180 may function as a rough equivalent of a merchant in a payment transaction, communicating an authorization request to an issuer server 198 via a payment processing network 196 and an acquirer server 194. Additionally, service server 180 may function to distribute portions of received payments to accounts associated with content server 160 and various host sites, as will be described in more detail below.

User system 110 may also be referred to as a user computing device. User system 110 may be any computing device or computer suitable for displaying multimedia content to a user, and may include telephones, notebook computers, tablet computers, as well as portable television and video players. User input 130 may then be any user input such as a keyboard, and phone keypad, a touch screen, or a voice input. Display 120 may be any display for a computing device such as a liquid crystal display, a plasma screen display, a cathode ray-tube display, or any other display that may present multimedia or video output. Additional embodiments and details related to computers and computing devices are described below, especially with regard to FIG. 16.

Video player 140 may comprise any combination of hardware and software components that may implement a video player within user system 110 having the described modules. Video play module 142 enables presentation of content to a display 120, as well as display of payment related information such as a payment balance for locally stored virtual credit information, as will be described later, and interrupt information for requesting payment from a user. Video play module 142 may interact with an integrated payment module 146 to present the balance and payment request information to a user.

Payment module 146 may function to accept payment information such as credit card information from a user input 130, and communicate the payment information to service server 180. Payment module 146 may further function in conjunction with content segmenting module 144 to receive control of video player 140 at the end of a content segment with payment is required and a request for payment is to be presented to a user via display 120. The payment mechanisms enabled by the payment module 146 include a virtual wallet balance, payment by virtual currency, and payment method using a profile to perform an authentication of an issuer based payment method may are embedded inside the player 130 as part of payment module 146. This functions such that the video player 130 has the ability to prompt a user to pay, the player 130 further has the ability to pause or play the video content based on the status of the payment acceptance, or to collect the actual payments via payment information from the user and/or from a service server. This player 130 including payment module 146 may then be distributed widely on the internet and host sites, while maintaining the ability to collect revenues from viewers of the content and payout to the original publishers of the content as well as the distributor host site operators.

A user can be an individual or organization such as a business that is capable of purchasing goods, services, or currencies or making any suitable payment transaction. In some embodiments, a user may further be referred to as an account holder, and can refer to a consumer who has an account with an issuer or service that provides monetization services. A user may have multiple virtual and non-virtual accounts.

A virtual account refers to an account with credits denominated in a virtual currency. A virtual currency is a credit or value that may be used to make a purchase, but which does not have a legal quality of money, and which may be implemented within the context of a game world or an internet based value exchange.

A non-virtual account refers to an account denominated in legal tender, such as a credit card, debit card, etc., that can assist in the use of the account to conduct a transaction.

Content refers to electronic information having a pre-defined beginning and end, which may be presented to a user. One potential example of content is a movie having a beginning portion including a title and an end portion including credits. An alternative embodiment of content is a music video, where beginning, middle, and end portions may be determined from repeated patterns of verses and choruses within a song. In further embodiments of content, markers may be placed within content to define beginning and end portions of the content.

A segment or content segment, is a portion of a content. The segment may be defined as a percentage of the content, or as a fixed length from a start or end of the content. Segments may further be identified and created by analysis of data within content, such as analysis of video frames to identify a title or a beginning of a credits sequence, such that large volumes of content may have similar segments identified through processing and analysis of the content.

A preview segment is a first portion of a content from the beginning of the content to a variable point within the content. Typically, a preview segment refers to an initial segment which is presented or displayed without charge.

An acquirer can be any suitable entity that has an account with a merchant and that processes merchant transactions associated with merchant access device. For example, an acquirer may be a bank.

An issuer can be any suitable entity that may open and maintain an account associated with a user. For example, an issuer may be a bank, a business entity such as a retail store, or a governmental entity that issues a payment account to a user. In some embodiments, an issuer may also be the acquirer in a given transaction. An issuer may also issue portable consumer devices that are associated with an issued account. Additionally, in some embodiments an issuer may create or group accounts into portfolios or sections of portfolios, and may store data related to users and transaction data for a portfolio.

A payment processing network such as payment processing network (PPN) can be a network of suitable entities that have information related to the account associated with a user and issued by an issuer. This Information includes profile information and other suitable information that may be used to complete a transaction between a user and a merchant involving an account.

Payment processing network may include data processing subsystems, networks, and operations used to support and deliver authorization services, exception file services, and clearing and settlement services. An exemplary payment processing network may include VisaNet™. Networks that include VisaNet™ are able to process credit card transactions, debit card transactions, and other types of commercial transactions. VisaNet™, in particular, includes an integrated payments system (Integrated Payments system) which processes authorization requests and a Base II system which performs clearing and settlement services. Payment processing networks may use any suitable wired or wireless network, including the Internet. Payment processing network may further include components such as an access control server, which can be a server computer that provides issuers, or other entities with the ability to authenticate consumers during an online transaction. In some embodiments, the payment processing networks may include a directory server that can refer to a server computer that can be used to route messages containing enrolment and authentication information between a merchant plug-in or an access control server. The directory server can also determine whether a consumer can utilize the authentication services and can apply business rules to modify the response to a merchant plug in. In some embodiments, the directory server can be operated by a service organization such as Visa. Alternatively, the above discussed portions of payment processing networks may be created as part of alternative networks coupled to payment processing network. Further embodiments may have various combinations or multiple copies of the above network elements, or may not include all of the above network elements.

FIG. 2 further describes aspects of a system that may describe a method for monetizing content in segments over the internet in conjunction with the system of FIG. 1. FIG. 2 comprises service server 180, content servers 160a and 160b, players 261a and 261b, first site 250a, second site 250b, and embedded players 240a and 240b.

According to FIG. 2, service server 180 may serve the same function as described in FIG. 1. Additionally, as described by FIG. 2, service server 180 may be in communication with multiple content servers 160. The content servers may be unrelated, or may be mirror images serving the same content. In certain embodiments, service server 180 may be part of the same network, server, or group of servers as one or more content servers 160. Each content server 160 may operate using a player 261 to distribute content to sites 250.

Player 261 describes structure or software instructions that may be used to create a player within a host site that has an imbedded payment module such as payment module 146. As such, player 261 may function in conjunction with a user system 110 to create and/or operate a video player 140. Player 261a may be the same as player 261b, or they may be completely different players in terms of structure and function. Further, each content server 160 may be associated with multiple players that will be used based on the specifics of a user system 110. The first time a user system 110 visits a site 250 with an embedded player 240, the associated player 261 may be communicated from a content server 160 to a user system 110. Thereafter, the player 261 may be present on the user system 110, or the player 261 may require a new download for each content from a content server 160.

First site 250a and second site 250b may be locations or host sites with addresses accessible via the Internet. As part of each site 250, a player 261 may be embedded in the site to create an embedded player 240. Embedded player 240 functions as the site 250 equivalent of video player 140, such that a player 260 in conjunction with a user system 110 creates video player 140 with a video play module 142 and a payment module 146.

FIG. 3 describes a method for monetizing content in conjunction with various implementations of the system described in FIGS. 1 and 2. In step S300, a user that has been authenticated or registered with a service server visits a site such as site 250a having an embedded player with an integrated payment module such as payment module 146 according to an implementation of the innovations herein. In step S310, the embedded player displays a first segment, or a preview segment of the content in the embedded player such as embedded player 240a as part of the site 250a.

In step S320, the embedded player passes control from video play module 142 to payment module 146 when the preview segment of the content ends. In the embodiment described in FIG. 3, the user has been previously authenticated or registered and signed in, and the payment module 146 presents a payment request via display 120 to the user, requesting payment from the user for permission to view the next segment of the content.

In step S330, the user elects to pay for the next segment using user input 130, and in step S340, payment is accepted and the embedded player plays the next segment. Once a user has paid for the video content after the allotted preview time, the user may be granted access to that content in several manners which would include renting the content for a specific number of views. This may be, for example a single view, five views, or any set number of views. This may alternatively be for a specific period of time, for example 1 or more days. In some embodiments, a combination of the previous two options may enable a specified number of views within a given time period, such as five views per year. Alternatively, the user may gain ownership of a copy of that content for viewing at any time in the future without restriction for time or views. Such a copy may include digital rights management (DRM) limitations that limit creation of further copies, or may be free of DRM limitations.

In an additional alternative embodiment, a video player may comprise a video play module and a payment module. The video player may be integrated with content to create a distributed video player. The distributed video player may then be communicated by a network to a user computing device. When the user computing device elects to play the content included with the distributed video player, the distributed video player may request a payment be transferred prior to display of the content. The payment process may then function in accordance with any of the above describe payment methods, using virtual are direct payments, and a content ID to provide a monetizing service to the content provider. The distributed video player may include additional security features when communicated to a potential viewer, including secret codes, login registration, security symbols, or two way authentication to verify that the distributed video player originates from a trusted source.

Additional details related to more specific implementations of steps S330 and steps S340 will be detailed below.

FIG. 4 describes further methods and details related to one potential implementation of the innovations presented herein. In step S400, a content provider with content that the content provider wishes to monetize formats a certain piece of content for a player. The formatting may include defining segments for the content, and defining payment options for the content in conjunction with player functionality. In certain embodiments, the content provider may register with a service to obtain an ID and payment agreement, or the content provider may simply accept a standard agreement with a player.

In step S410, the content provider may then provide the player with formatted content to sites, so the sites may imbed content from the content provider into the host site. Similar to the process for the content provider above, the sites may register with a service to create an agreement and site ID, or may simply accept a standard agreement with a player as part of embedding the player into the site.

In step S420, a user visits a site with the embedded player, and downloads the player to create a video player with an embedded payment module. Then in step 430, the video player plays a first segment as part of the host site. At this point, the system provides a benefit in that for unregistered users, the user is able to fully experience the site including a first portion of the content with the same experience as a registered user.

In step S440, then the video player passes control from a video play module to a payment module, and the player checks for registration and/or login information. The payment module may then request payment from the user to display the second segment of the content.

In step S450, a user declines to pay for the next segment. Following an input declining to pay for a second segment, payment module may update a viewing and payment history with an indication of the content displayed and the non-payment selection in step S452. Such an update may occur even if the payment module never has an opportunity to present an option to pay. For example, if the video player is playing a first segment of a content, and a user system navigates away from a site prior to completion of the first segment, the payment module may count the browsing away from the site as a non-payment selection, or as some other field in a viewing and payment history.

In step S460, if an unregistered user opts to make a payment to view the second segment, a payment module may accept payment information from the user within the embedded player, communicate the payment information to the service servicer, and receive authorization from the service server to view the second content segment. While such a registration does interrupt the viewing process, the registration includes the benefit of functioning from within the video player to provide the most seamless experience possible, provides a benefit of creating registration for future use of the embedded player, and allows the user to begin viewing the content without an initial up-front payment. In step S462, then the player plays the second segment of the content.

If, on the other hand, the user was previously registered, in step S470 the user may sign in if not previously signed in, and then may simply select a payment method. Preferably the payment method is directly associated with the user sign-in such that the user may simply make a single click selection for payment. If not, the user may again be presented with payment information entry from within the video player to present as seamless an experience as possible. Then following approval of the payment election, the player plays the second segment of the content.

FIG. 5 details a method of monetizing multimedia content including payment via a payment module that requires authorization approval from an issuer. In step S500, a user registers with a video segment service and/or with a trusted party that has a federating agreement with the video segment service. If the trusted third party is the party with the embedded player in a host site, the player may include the option to allow payment information held by the trusted third party to pay for segments of content requiring payment.

Further, as part of a registration process in various implementations of the innovations presented herein, the user may select various options and alternatives, including an option to store payment information with a service server or trusted third party that may enable single click payment for viewing of content segments requiring payment.

Following registration, in step S502, the user visits a host site with an embedded player, and downloads the embedded player with the integrated payment modules. In step S504, the user selects content for viewing with the video player. The video player may present an option of multiple pieces of content for a user to select from within the video player. Alternatively, the player may be integrated with a single piece of content, where selection of the single piece of content is the only option within a given player, and a host site may include multiple embedded video players.

In step S506, the video player plays, downloads, or streams a first segment of the content from the content server to a user system. The video player may function by downloading an entire content, and playing a first portion of the content based on a segment marker in conjunction with a content segmenting module. Alternatively, the content may be streamed real time or downloaded in segment pieces, with subsequent segments not downloaded or streamed from the content server until payment is selected or verified.

In step S508, the video player ceases playing after the completion of the first segment of the content, and the payment module of the video player is given control to request payment for the next segment. In step S510, the user elects a method of payment requiring authentication to pay for the next segment. This election may require entry of user payment information using a user input at the user system, or may simply be a login verification or one click selection that uses payment information stored at a service or third party server as part of the registration process.

In step S512, following the user payment request and the user approval selection, the payment module communicates the user payment request approval to the service server to check account details, payment information, and account credits. In one potential embodiment, the service server includes a virtual currency account, and the payment is a request to fill an order for virtual currency when the virtual currency account is lower than an amount of virtual currency required to pay for a next segment of content.

In step S514, the service server verifies payment information from the payment module based on the type of user approval. In step S516, the service server then communicates an authorization request based on the payment information. In one potential implementation, this information comprises credit card information communicated to an issuer through an acquirer and a payment processing network. Any other suitable authorization process may be involved.

In step S518, the service server receives an authorization response, and local service server accounts are updated. As part of this step, any needed updates to virtual currency accounts may be made.

In step S520, the service server communicates the authorization response to the payment module of the player, where the response may be communicated to the user. In step S522, the player plays the next segment if the payment is approved. Finally, in step S524, any digital rights associated with the purchase that are recorded at the video player may be updated, and any user payment history recorded at the player level may also be updated.

In one potential alternative embodiment, rather than waiting until step S522 to play the next segment, an alternative embodiment may begin playing the second segment immediately upon communication of payment information to the service server. In such an embodiment, if a rejection is received from the issuer, or if a response is not received to the authentication request within a predetermined time, the display of the second segment of the content may be interrupted until payment approval is received.

FIG. 6 describes one potential alternative implementation of the system of FIG. 1. FIG. 6 comprises a user system 610, a content server 660, a service server, 680, an acquirer server 694, a payment processing network 696, and an issuer server 698. In the embodiment described in FIG. 6, user system 610 comprises a display 620, a user input 630, and a video player 640. The video player comprises a video play module 642 and a payment module 646. The display 620 comprises a content portion 624, a payment balance portion 622, and an interrupt portion 626. By contrast with the system of FIG. 1, in the system of FIG. 6, the content segmenting module is in the content server.

As described above, when the content segmenting module functions within the video player as in user system 110 of FIG. 1, significant local control of content segmenting and display may be operated from user system 110, where content is downloaded or streamed to user system 110 but not displayed until a user accepts a payment request or until a payment request is authenticated. Additionally, in a system such as the system of FIG. 6, video player 630 or service server 680 may be required to communicate payment approval to content server 660, which further complicates system messaging. However, such a system where additional content segments are not communicated until after payment is verified or accepted provides additional security from potential hacking or fraud where the system may display content at a user system when payment has not been correctly made.

Additionally, in still further embodiments, service server and content server may, in some embodiments, comprise the same server created and operated by the same entity, and in certain embodiments, host sites with imbedded players may further operate using the same server or servers as the content and server servers.

FIG. 7 describes an additional embodiment that enables single click monetization with virtual currency integrated and presented to a user with a payment module. Single Click Payment with pre filled wallet allows the video player to carry a pre-filled wallet balance. This balance may always shown visibly while the video content is playing, after the balance is received from a service server. When the paid segment video starts, the user is prompted to pay with the pre-filled wallet with a single click. When the user clicks on pay, the wallet balance is deducted and the video continues. If the user does not have a balance sufficient to make payment, the user may refill the wallet by clicking in a re-fill button where the user will be prompted to select an amount of money to add to the wallet through various payment methods.

In another embodiment, single click payments are enabled with Virtual Currencies: The video player allows users to carry a pre filled virtual currency wallet balance. This balance is always shown visibly while the video content is playing. When the paid segment video starts, the user is prompted to pay with the virtual currency wallet with a single click. When the user clicks on pay, the virtual currency balance is deducted and the video continues. If the user does not have a balance sufficient to make payment, the user may refill the virtual wallet by clicking in a re-fill button where the user will be prompted to select an amount of money to add to the wallet through various payment methods.

In another alternative embodiment, single click payments are enabled with a Payment Profile. When the paid segment video starts, the user is prompted to pay with the payment profile on file for the user (such as a stored credit card account). When the user clicks on pay, the payment method on profile is charged (or debited) and the video continues. If the user does not have a payment method on file, the user is prompted to add one of various payment methods that are displayed to the user by the player. The actual charge of the payment instrument may occur at the time the user clicks pay, or may be aggregated and the users payment instrument charges at a later time after a certain payment threshold is reached, or a certain amount of time has elapsed. Examples of payment profiles on file instruments include payment services such as credit or debit cards on file through an online service.

In Step S700, a service provider defines segment, preview, and payment options for a piece of content. The service provider may specify a price in terms of virtual currency, such as UltimatePoints™, real currency such as dollars, or both. In such an embodiment, rather than setting price by the content provider, the content provider may allow some pricing decisions to be performed by a service provider with flexible pricing based on system analytics.

In Step S702, a user registers with a video segment service. Such a registration may include purchase of virtual currency, and creation of a virtual currency account with the segment service that controls a service server.

Later, in step S704 a user using a user computing device browses to a site including an imbedded player, and the user downloads the player with the integrated payment module. In step S706, when the payment module is functioning within the user computing device, the payment module identifies and login or identifying registration for the user, and communicates with a service server to check registration and account credits. Login or identifying registration may be identified by the payment module from stored cookie information at the user device, or from a password protected login at a host site or within a video player. A user's identity may therefore be tied to the viewing of the video content by a host site prompting the user to login, and then communicating send all or some part of that users information or profile to the video player as part of a federated login system. Alternately, the video player can prompt the user to login to an account such as by asking for a user name and password in order to gain access to the payment instrument provided by the player.

In step S708, the service server communicates account credits to the video payment module, which may store a current account balance of virtual currency to enable immediate use of the virtual currency. In steps S710-S714, the video player plays a first content segment in response to a user selection, and interrupts the content after the first segment to request payment approval for the next segment. When a user ID has been verified, the payment module may enable single click payment.

In step S716, the user responds to payment request with a user payment request approval, preferably by selecting a single click approval. In step S718, the system checks locally for a pre-filled wallet that may include virtual currency credits. If the local credits are sufficient to pay for the next segment, the system jumps to step S724. If the local credits are not sufficient, the system may communicate with service server in step S720 to identify a payment profile to automatically request payment based on a pre-stored payment profile. This enables a second option for a single click payment to be approved. The payment profile may be pre-configured to refill a wallet, or simply to pay directly for a purchase selection. If no payment profile is available the system goes to step S722, where the user is presented with an option to enter payment information. If the user enters payment information, the system goes through a payment approval process using payment information entered by the user to refill a wallet or to pay for the next segment. In step S724, after a payment is authenticated via a service server, a wallet is refilled or a payment for the content segment is verified.

In step S726, if payment is made from a wallet, the wallet credits are verified against the content segment cost, and the account is updated. If payment is made directly for the content segment, the transaction approval is used to authorize the payment module to return control to a video play module to play the next segment of the content. Information indicating viewing of the next segment and updating any payments made from a wallet are then communicated to the service server to update the system and any account credits.

FIG. 8 describes a service server 880 that may be similar to service server 180 of FIG. 1 or service server 680 of FIG. 6. Service server 880 comprises a user database 810, analytics module 830, virtual transactions module 850, purchase module 860, and settlement module 890.

User database 810 may comprise user configuration 812, payment options 814, one-click payment setup 816, sign-in and federation options 818, user payment history 820, and virtual currency management 822. User configuration 812 may include login and password information, as well as a list of multiple identities and/or logins associated with other server and services. These servers and services may be considered trusted third parties for the purposes of login and payment, such that a service server may receive an indication that a user has logged-in with a third party trusted service. Sign-in and federation options 818 may be set by a user to allow this third party sign-in to be considered an equivalent to a service sign-in, and to enable payment using payment options and information for virtual wallet 814 based on the trusted third party log-in.

Payment options 814 may hold a record of payment information such as credit card information, debit card information, or virtual currency top-up that sets a default payment when a service server receives an approval from a payment module. These payment options 814 may further include fraud protection options such as spending limits or notification caps for requiring extra approval or limits on spending under federated login options. This may work in conjunction with one click payment setup 816, which may enable a user to select a preference for virtual currency or authentication based payment where a single click payment may have the option of using either payment type. Setup 816 may further be an approval and agreement for functioning of a single click payment system as part of a server service. User payment history 820 may include a record of segments watched, segments completed, segments purchased, or any other information relevant to a user. Such information may additionally include a content provider ID for tracking different content provided by a single content provider, and site ID history for tracking different content viewed by a host site in which the content was embedded. Finally, virtual currency management may include a current balance of a virtual currency account or multiple virtual currency accounts. Because a single user may have many currencies associated with many different individual games, sites, and services, the virtual currency management may include a large number of accounts, as well as accounts that may be used to engage in currency conversion between different virtual currencies.

Virtual transactions module 850 may handle user payment request approvals from video player payment modules that are to be settled using virtual currency. Selection of virtual transaction module may be made by an indication from a user system, or may be made based on user settings from user database 810. Virtual transactions module 850 may receive a payment request, initiate a fraud analysis, check a virtual currency account from virtual currency management 822, and respond to a user payment request acceptance with an transaction approval or a transaction rejection message. In embodiments where a wallet of virtual currency is maintained in a video player, virtual transactions module 850 may receive a message indicating that a purchase was made using a wallet, reconcile the payment with virtual currency management 822 to update account credits, and communicate with a video player payment module regarding settlement and/or fraud notifications and payment rejections. As such, in some embodiments, virtual transactions module may be functionally equivalent or operating as the same module as user module 896 of settlement module 890.

Similar to virtual transactions module 850, purchase module 860 may handle user payment request approvals from video player payment modules that are to be settled using other payment information, such as credit card information received directly from a video player payment module. Selection of purchase module may be made by an indication from a user system, or may be made based on user settings from user database 810. Purchase module 850 may receive a payment request, initiate a fraud analysis, and initiate an authorization with an issuer via a payment processing network. The payment request may be for a purchase of virtual currency, in which case the virtual currency management 822 is updated with increased credits following a successful purchase. If the payment request to an issuer is for a specific content segment, when purchase module receives an authorization response following a payment request to an issuer, the purchase module notifies the user and communicates a transaction approval to the video player payment module. In embodiments where a wallet is maintained in a video player, purchase module 850 may receive a message indicating that a purchase was made using a wallet, reconcile the payment, and communicate with a video player payment module regarding settlement and/or fraud notifications and payment rejections. As such, in some embodiments, purchase module may be functionally equivalent or operating as the same module as user module 896 of settlement module 890.

Analytics module 830 may store and analyze analytics data collected from content segment purchases in order to enable improved business analysis and feedback systems for content providers. For example, analytics data may be payment history, content type, content ID, content producer ID, siteID, user age, aggregate content data or other similar relevant data. In various embodiments, a service server 880 may receive additional information related to specific content providers, content, host sites, users, and players as part of payment module messaging for transaction approval and data collection. Use analysis and service optimization 832 may analyze this information for content providers and content from content database 834, from host site database 836, from player database 838, and from user payment history 820. Use analysis and service optimization 832 may, for example, identify incompatibilities and errors for certain content and certain players if the segment completion is especially low or ends and an unusually specific portion of a segment.

Analysis 832 may additionally provide feedback to content providers and host sites, or any party that controls segment selection, to identify segments for a particular content or type of content that provides improved conversion rates of non-paying users to paying users. For example, a particular movie content may provide a variable preview segment of either four, five, or six minutes. If the six minute preview segment provides a significantly larger rate of payment for the next segment, analytics module 830 may convey this information to increase the number of users offered the six minute preview segment for the particular content. Similar analysis may be done for segments which the user pays for, for segment costs, or for categories of content where the content items are similar but not identical.

Settlement module 890 comprises modules for content settlement 892, host site settlement 894, and user settlement 896. After payment for particular content is received at service server 880, the monetization for the content provider and the host site associated with the payment needs to be settled, where a portion of the user payment is transmitted to the appropriate parties. These parties may be identified by content ID, content provider ID, and host site ID from the video player payment module. Content settlement 892 and host site settlement 894 may occur immediately upon receipt of payment from a user. Alternatively, a content provider or host site may have an account with a service provider and service server 800, where the payments due are aggregated over a period of time and conveyed to the appropriate party when a certain monetary value is reached or at the end of a specified period of time.

FIG. 9 describes one potential embodiment of a content server, which may be similar to content server 160 of FIG. 1 or content server 660 of FIG. 6. Content server 960 of FIG. 9 includes content database 962, content segmenting and streaming module 964, player specific payment conversion success module 966, content specific payment conversion success module 968, global payment conversion success module 970, site specific payment conversion success module 972, and content player module 990. Content database 962 may comprise a collection of content owned and or created by a content provider that controls content server 960. Content database 962 may further include details relating to content segments and conversion rates for content.

Content player module 990 may comprise players customized for particular content, for particular host sites, and or for particular users. When a embedded player is placed in a host site, and a user visits the site, a user system such as user system 110 or 610 may communicate with content server 960 to request a particular player. Instructions for the particular player may then be communicated to the user system to provide video player with an integrated payment module functioning in a user computing device or user system 110.

Content segmenting and streaming module 964 may functionally segment the content at content server 960 as described in the embodiment of FIG. 6. Alternatively, content segment and streaming module 964 may simply communicate the content to a user system for segmenting at the user system. In another potential embodiment, content may be altered with tags embedded in the content to identify the segments. When such a file is communicated to a user system, a content segmenting module such as content segmenting module 144 may use such tags to segment the file at the user system.

Content server 960 additional may include modules that function in a fashion similar to analytics module 830 of FIG. 8. Content server 960 may receive use data directly from user systems that identify content specific payment conversion, host site specific payment conversion, or player specific payment conversion rates. Modules 966, 968, 970, and 972 may use this information to perform analysis of revenue, and to adjust segment, host site, and player characteristics and locations controllable by the content server in an attempt to increase revenue from content. In many embodiments the content server may directly control the creation and setting of content segments, and so as in the example presented above, a the six minute preview segment provides a significantly larger rate of payment for the next segment based on analysis from conversion success modules, a content segmenting and streaming module 964 and any associated characteristics in a content database 962 may be adjusted to alter segments provided to users, thereby potentially increasing revenues associated with the content.

As described above, various embodiments disclose communication from a payment module directly to a service server, and communications from a content display management module of a video player to a content server. In alternative embodiments, these system elements may be disposed via any route. For example, in certain embodiments, communications from a payment module may be sent to a content server, and then directed to a service server. Alternatively, content segment information may be communicated from a content server to a user system via a service server. Further still, players and content may be provided from separate servers to a user system, and players and content may further be provided either directly from an originating server of by being embedded in a third party host site.

FIG. 10 describes another potential embodiment of a method of monetizing content in accordance with the above described servers and systems. In step S1010, a content provider defines segment, preview, and payment options for content and a player. A content ID and a player ID are assigned, either by the content server or the service server in communication with the content server.

In step S1012, a host site embeds content within a third party host site, and a site ID is assigned, again either by the site or by the service server in communication with the site.

In step S1014, a user registers with the segmenting service or an affiliate site, and a user ID is assigned. The user ID may be assigned when a user communicates with a service server, may be assigned by a trusted third party or affiliate when a user registers with the third party, or may be assigned when the third party communicates with the service server regarding any accounts associated with the user.

In step S1015, a user selects content for viewing from a host site. The video player on the user's system plays a first segment of the content. A content ID, site ID, player ID, and user ID may be communicated to a service server when the content segment is selected, during display of the content segment, or after the content segment has completed.

After the preview content segment has completed, in step S1018 the content is interrupted to request payment from the user. When a user responds to the request for payment with a user payment request approval, the user payment request approval is communicated from a payment module of the video player on the user system to the service server along with a content ID, site ID, player ID, and user ID. In step S1022, the content ID, site ID, player ID, and user ID enable the service server to distribute payment to content providers, host sites, and other third parties in response to receipt of payment from a user having the appropriate ID. As discussed above, these payments may be aggregated, or may be sent on a per payment bases as revenue is received from a user by a service server.

Aggregated sets of ID data in conjunction with user selection, segment length, payment type, and any other suitable information available to the service server and/or content server may then be used to analyze system function in step S1024. Then in step S1026, adjustments to segment lengths based on feedback success rates may be set. These adjustments may be made on a user specific basis or a global basis. These adjustments may also be based on a specific content, or groups of content having similar characteristics such as length, host site, or content creator.

FIGS. 11-15 present potential interface, currency, and display presentations that may function as part of a user computing device operating in accordance with embodiments of the present innovations. FIGS. 11-15 present display aspects similar to display 120 of Figure

FIG. 11 illustrates an embodiment where content is displayed in a content portion of a display, such as content portion 124 of display 120 described in FIG. 1. Along the top of the display, a local wallet balance of 995 units of virtual currency denominated in UltimatePoints is presented. A cost for the current segment in UltimatePoints is displayed along a bottom portion of the display. In another potential embodiment in accordance with the present innovations, a preview portion of a content may be displayed, and a payment request set for a second portion may be structured for automatic payment. A local wallet may be charged, after a visual or sound warning, while the content plays continuously through the first segment into the second segment. After the second segment begins, the wallet is charged for the second segment, and a local wallet balance is decreased by the cost of the second segment. A single click interface may be used to refill a local wallet balance to allow a content to continue playing.

One potential embodiment of such innovations is shown in FIG. 11, where the 995 UPoints are displayed on the top right corner, as well as a button allowing the user to refill, re-charge, or “top up” the virtual currency wallet.

FIG. 12 illustrates an embodiment of the invention where an overlay on the video created within the video player functioning as a payment request prompting the user to refill the virtual currency wallet. Alternatively, such an overlay may be presented as an interface when a refill button is selected. In alternative embodiments, multiple virtual and non-virtual currencies may be presented for selection to pay for content segments and wallet refills.

FIG. 13 illustrates an embodiment of the invention where the video content has been halted and the user is prompted to pay with virtual currency payment of 10 UPoints to continue displaying the content on a user computing device.

FIG. 14 illustrates an embodiment of the invention where a user has credit card payment instrument on file that may be used for a one click purchase of the video content segments.

FIG. 15 illustrates an embodiment of the invention where a user is shown multiple video content options within a site. The video content options that includes paid video content, and shows the price of paid or premium content in a virtual currency (here called UPoints). In various embodiments, multiple video content options may be present at a host site, and the content may be imbedded with one or more different players from different content servers or directly from the host site.

FIG. 16. illustrates an exemplary computer system 1600, in which various embodiments may be implemented. The system 1600 may be used to implement any of the computer systems described above (e.g., client computer, a server computer at the payment processing network, a computer apparatus at the merchant, etc.). The computer system 1600 is shown comprising hardware elements that may be electrically coupled via a bus 1624. The hardware elements may include one or more central processing units (CPUs) 1602, one or more input devices 1604 (e.g., a mouse, a keyboard, etc.), and one or more output devices 1606 (e.g., a display device, a printer, etc.). The computer system 1600 may also include one or more storage devices 1608. By way of example, the storage device(s) 1608 can include devices such as disk drives, optical storage devices, solid-state storage device such as a random access memory (“RAM”) and/or a read-only memory (“ROM”), which can be programmable, flash-updateable and/or the like.

The computer system 1600 may additionally include a computer-readable storage media reader 1612, a communications system 1614 (e.g., a modem, a network card (wireless or wired), an infra-red communication device, etc.), and working memory 1618, which may include RAM and ROM devices as described above. In some embodiments, the computer system 1600 may also include a processing acceleration unit 1616, which can include a digital signal processor DSP, a special-purpose processor, and/or the like.

The computer-readable storage media reader 1612 can further be connected to a computer-readable storage medium 1610, together (and, optionally, in combination with storage device(s) 1608) comprehensively representing remote, local, fixed, and/or removable storage devices plus storage media for temporarily and/or more permanently containing, storing, transmitting, and retrieving computer-readable information. The communications system 1614 may permit data to be exchanged with the network and/or any other computer described above with respect to the system 1600.

The computer system 1600 may also comprise software elements, shown as being currently located within a working memory 1618, including an operating system 1620 and/or other code 1622, such as an application program (which may be a client application, Host browser, mid-tier application, RDBMS, etc.). It should be appreciated that alternate embodiments of a computer system 1600 may have numerous variations from that described above. For example, customized hardware might also be used and/or particular elements might be implemented in hardware, software (including portable software, such as applets), or both. Further, connection to other computing devices such as network input/output devices may be employed.

FIG. 17 illustrates a schematic diagram of a system 1700 that can be used in accordance with one set of embodiments. The system 1700 can include one or more user computers 1705 functioning as computing devices or servers within a network. The user computers 1705 can be general purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially-available UNIX™ or UNIX-like operating systems. These user computers 1705 can also have any of a variety of applications, including one or more applications configured to perform methods of the invention, as well as one or more office applications, database client and/or server applications, and host browser applications. Alternatively, the user computers 1705 can be any other electronic device, such as a thin-client computer, tablet computing device, Internet-enabled mobile telephone, and/or personal digital assistant (PDA), capable of communicating via a network (e.g., the network 1710 described below) and/or displaying and navigating host pages or other types of electronic documents. Although the exemplary system 1700 is shown with three user computers 1705, any number of user computers can be supported.

Certain embodiments of the invention operate in a networked environment, which can include a network 1710. The network 1710 can be any type of network familiar to those skilled in the art that can support data communications using any of a variety of commercially-available protocols, including, without limitation, TCP/IP, SNA, IPX, AppleTalk, and the like. Merely by way of example, the network 1710 can be a local area network (“LAN”), including, without limitation, an Ethernet network, a Token-Ring network and/or the like; a wide-area network (WAN); a virtual network, including, without limitation, a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks.

Embodiments of the invention can include one or more server computers 1715. Each of the server computers 1715 may be configured with an operating system, including, without limitation, any of those discussed above, as well as any commercially (or freely) available server operating systems. Each of the servers 1715 may also be running one or more applications, which can be configured to provide services to one or more user computers 1705 and/or other servers 1715.

Merely by way of example, one of the servers 1715 may be a host server, which can be used, merely by way of example, to process requests for host pages or other electronic documents from user computers 1705. The host server can also run a variety of server applications, including HTTP servers, FTP servers, CGI servers, database servers, Java™ servers, and the like. In some embodiments of the invention, the host server may be configured to serve host pages that can be operated within a host browser on one or more of the user computers 1705 to perform methods of the invention.

The server computers 1715, in some embodiments, might include one or more application servers, which can include one or more applications accessible by a client running on one or more of the client computers 1705 and/or other servers 1715. Merely by way of example, the server(s) 1715 can be one or more general purpose computers capable of executing programs or scripts in response to the user computers 1705 and/or other servers 1715, including, without limitation, host applications (which might, in some cases, be configured to perform methods of the invention). Merely by way of example, a host application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™, and the like, which can process requests from clients (including, depending on the configurator, database clients, API clients, host browsers, etc.) running on a user computer 1705 and/or another server 1715. In some embodiments, an application server can create host pages dynamically for displaying the information in accordance with embodiments of the invention, such as information displayed on host browser 106 in FIG. 1. Data provided by an application server may be formatted as host pages (comprising HTML, Javascript, etc., for example) and/or may be forwarded to a user computer 1705 via a host server (as described above, for example). Similarly, a host server might receive host page requests and/or input data from a user computer 1705 and/or forward the host page requests and/or input data to an application server. In some cases a host server may be integrated with an application server.

In accordance with further embodiments, one or more servers 1715 can function as a file server and/or can include one or more of the files (e.g., application code, data files, etc.) necessary to implement methods of the invention incorporated by an application running on a user computer 1705 and/or another server 1715. Alternatively, as those skilled in the art will appreciate, a file server can include all necessary files, allowing such an application to be invoked remotely by a user computer 1705 and/or server 1715. It should be noted that the functions described with respect to various servers herein (e.g., application server, database server, host server, file server, etc.) can be performed by a single server and/or a plurality of specialized servers, depending on implementation-specific needs and parameters.

In certain embodiments, the system can include one or more databases 1720. The location of the database(s) 1720 is discretionary: merely by way of example, a database 1720a might reside on a storage medium local to (and/or resident in) a server 1715a (and/or a user computer 1705). Alternatively, a database 1720b can be remote from any or all of the computers 1705 or servers 1715, so long as the database 1720b can be in communication (e.g., via the network 1710) with one or more of these. In a particular set of embodiments, a database 1720 can reside in a storage-area network (“SAN”) familiar to those skilled in the art. (Likewise, any necessary files for performing the functions attributed to the computers 1705 or servers 1715 can be stored locally on the respective computer and/or remotely, as appropriate.) In one set of embodiments, the database 1720 can be a relational database, such as an Oracle™ database, that is adapted to store, update, and retrieve data in response to SQL-formatted commands. The database might be controlled and/or maintained by a database server, as described above, for example.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

What is claimed is:

1. A method for displaying multimedia content comprising:
displaying, by a user computing device, a first segment of a content, wherein the content comprises a plurality of segments;
displaying following display of the first segment of the content, a request for payment associated with a second segment of the content;
communicating a user payment request approval for the second segment of the content;
receiving a transaction approval for payment of the second segment of the content; and
displaying, by the user computing device, the second segment of the content.

2. The method of claim 1 wherein the content comprises video content;
wherein the video content and the request for payment are displayed using a video player; and
wherein the video player comprises an embedded payment module.

3. The method of claim 1 wherein the first segment of the content is set by a communication from a content server indicating a period of the content.

4. The method of claim 3 further comprising communicating to a content server during display of the first segment of the content, a user ID associated with the user computing device; and
wherein the percentage of the content is set in response to analytics data associated with the user ID.

5. The method of claim 1 wherein a duration of the first segment of the content is set by the player based on a payment history stored in the player.

6. The method of claim 1 wherein displaying the request for payment comprises:
transferring control of the player from a video play module of the player to a payment module of the player.

7. The method of claim 6 further comprising:
identifying, using the user computing device and the player, a user ID;
communicating the user ID from the user computing device to the service server; and
receiving, from the service server prior to displaying the request for payment, a virtual currency account credit associated with the user ID.

8. The method of claim 7 wherein displaying the request for payment further comprises comparing the virtual currency account credit with a cost associated with the second segment of the content; and
displaying a single click approval interface when the virtual currency account credit is greater than the cost associated with the second segment of the content.

9. The method of claim 8 wherein the second segment is displayed immediately upon selection of the single click approval interface.

10. The method of claim 8 wherein communicating the user payment request approval comprises communicating an approval selection, an ID associated with the content, and an ID associated with the player to the service server.

11. The method of claim 10 wherein receiving, at the user computing device, the transaction approval for payment of the second segment of the content comprising:
receiving, from the service server, an updated virtual currency account credit reflecting deduction of the cost associated with the second segment of the content.

12. The method of claim 1 further comprising:
registering with the service server prior to displaying of the first segment; and
communicating to the service server, prior to display of the first segment, credit card payment information;
wherein the user payment request approval for the second segment of the content comprises an approval to pay for the second segment using the credit card payment information; and
wherein receiving approval for payment of the second segment of the content comprises receiving a transaction authorization message from an issuer associated with the credit card payment information.

13. The method of claim 1 wherein the displaying the second segment of the content occurs directly upon an affirmative response to the request for payment associated with the second segment of the content.

14. The method of claim 13 further comprising interrupting the displaying of the second segment of the content in response to receipt of a transaction rejection message from an issuer.

15. The method of claim 1 further comprising:
receiving, at the user computing device, a second request to display the second segment of the content;
checking, using the player, a payment history; and
displaying, using the user computing device, the second segment of the content in response to a payment history record for the second segment of the content.

16. A method for monetizing multimedia content comprising:
receiving at a server, a user payment request approval message indicating that a user computing device has displayed a first segment of a content and requesting approval for a payment associated with a second segment of the content;
verifying a registration status of the user associated with the user computing device and an association between the user and a payment account;
accepting, at the server, payment for the second segment of the content; and
communicating from the server to the user computing device, a transaction approval message associated with the second segment of the content.

17. The method of claim 16 wherein the user payment request approval message comprises a user ID and a content ID.

18. The method of claim 17 further comprising:
transferring, in response to accepting payment for the second segment of the content, a content payment to a content provider account associated with the content ID and a site payment to a site account associated with site ID.

19. A method of providing content to a user comprising:
formatting, using a content server, the content for a player that includes imbedded payment and segment interrupt modules, wherein the formatting comprises:
selecting a preview segment for the content;
selecting additional segments for the content; and
associating a cost for each segment other than the preview segment;
communicating, from the content computer to a user computing device, the content and the player.

20. The method of claim 1 wherein the method is stored as a set of computer readable instructions in a non-transitory computer readable instruction medium.

21. The method of claim 16 wherein the method is stored as a set of computer readable instructions in a non-transitory computer readable instruction medium.

22. The method of claim 19 wherein the method is stored as a set of computer readable instructions in a non-transitory computer readable instruction medium.

23. A device comprising:
a processor; and
a non-transitory computer readable instruction medium coupled to the processor including processor readable instructions for performing a method of monetizing content, the method comprising:
displaying, on a user computing device, a first segment of a content, wherein the content comprises a plurality of segments;
displaying, on the user computing device, following display of the first segment of the content, a request for payment associated with a second segment of the content;
communicating from the user computing device to a service server, a user payment request approval for the second segment of the content;
receiving, at the user computing device, a transaction approval for payment of the second segment of the content; and
displaying, on the user computing device, the second segment of the content.

24. A method for displaying multimedia content comprising:
receiving, at a user computing device, a distributed video player comprising an embedded payment module and a content;
selecting the content for display on the user computing device;
displaying, in response to the selecting the content for display, a request for payment from the payment module.

25. The method of claim 24 further comprising:
displaying, by the first user computing device, a first segment of the content prior to displaying the request for payment.

26. The method of claim 25 wherein the first segment of the content is displayed using the distributed video player, and the request for payment is displayed using the distributed video player.

27. The method of claim 26 further comprising:
communicating a user payment request approval;
receiving a transaction approval for payment; and
displaying, by the user computing device, a second segment of the content.
